(19) United States
(12) Patent Application Publication
(10) Pub. No.: US 2012/0212147 A1
(43) Pub. Date: Aug. 23, 2012

(54) Flyback Energy Converter

(75) Inventors: Chun-Chien Kuo, Hsinchu City (TW); Shao-Wei Chiu, Hsinchu City (TW); Ke-Horng Chen, Hsinchu City (TW); Wei-Lun Wang, Hsinchu City (TW)

(73) Assignee: ANWELL SEMICONDUCTOR CORP., Hsinchu City (TW)

(21) Appl. No.: 13/399,215

(22) Filed: Feb. 17, 2012

(30) Foreign Application Priority Data
Feb. 18, 2011 (TW) 100105327

(51) Int. Cl. H05B 37/02; H02M 3/335

(52) U.S. Cl. 315/219; 363/21.12

(57) ABSTRACT

The present invention is to provide a flyback energy converter comprising a transformer having a primary winding, a secondary winding and an auxiliary winding, a load electrically connected with the secondary winding, a switch serially connected with the primary winding and a primary controlling circuit. The primary controlling circuit comprises a voltage measurement terminal and a switch controlling terminal. The voltage measurement terminal measures an output voltage wave provided from the auxiliary winding to get a part of times in the part of the output voltage wave, so as to enlarge the part of times to a total time. According to a predetermined timing transferred from the total time, the switch controlling terminal controls the switch.

### BACKGROUND OF THE INVENTION

1. Field of the Invention

The present invention relates to a flyback energy converter. More particularly, the present invention relates to a flyback energy converter for outputting currents steadily.

2. Description of the Prior Art

In the prior art, a flyback energy converter feedbacks the output voltage by an opto-coupler for isolating the electric. However, the opto-coupler will be affected by the working temperature, so that the opto-coupler is replaced by a method of primary sensing.

The common method of primary sensing has two ways. One is to sense an input voltage and two terminal voltages of the switch when the switch is turned off. Another is to sense the voltage at an auxiliary coil. Wherein the first way has a problem about integrated circuits in high-pressure process, the cost cannot be decreased easily. The second way can sense the output voltage by the auxiliary coil, and the induced voltage generated by the auxiliary coil can be used as a power supply for the integrated circuits.

FIG. 1 illustrates a circuit diagram of a flyback energy converter according to the prior art. As shown in FIG. 1, a flyback energy converter 9 comprises a switch 90, a bridge rectifier 92, a controller 94 and a transformer 96. The transformer 96 comprises a primary coil Lp, a secondary coil Ls and an auxiliary coil La. The switch 90 is connected to the primary coil Lp. Wherein, an alternating output voltage Vac will be transformed into a direct input voltage Vin by the bridge rectifier 92. The direct input voltage Vin will be transformed into an output voltage Vout.

FIG. 2 illustrates a waveform diagram of a flyback energy converter according to the prior art. The wave 80 is the current of the secondary coil Is. The wave 82 is the voltage of the secondary coil Vds. When the switch is turned on (the period between t1 to t2, ton), a current will be generated at the primary coil. Additionally, the voltage Vds at the secondary coil is negative and there is no current at the secondary coil. When the switch is turned off (at t2), the voltage Vds at the secondary coil will be positive. Thus, a current Is is generated at the secondary coil (peak value Is_pk), then the current Is decline to 0 slowly in the period between t2 to t3 (toff). Assumed that the switching cycle of the switch is T, the average current I of the secondary coil Ls can be obtained by the following formula:

I=0.5×Is_{—}pk×toff/T formula (1)

However, the peak value of the current Is_pk can be set as a constant by the controller 94. According to the formula (1), if the toff/T is a constant, the average current I will be output steadily.

To sum up, developing a device outputting average current I steadily became an important issue in the field.

### SUMMARY OF THE INVENTION

Accordingly, a scope of the invention is to provide a flyback energy converter for outputting currents steadily.

According to an embodiment, the flyback energy converter comprises a transformer, a load, a switch and a primary controlling circuit. The transformer comprises a primary winding, a secondary winding and an auxiliary winding. The primary winding is electrically connected to a power supply. The load is electrically connected to the secondary winding. The switch is serially connected to the primary winding for controlling a primary current of the primary winding. The primary controlling circuit comprises a first voltage measurement terminal and a switch controlling terminal. Wherein, the voltage measurement terminal is used to measure an output voltage wave provided from the auxiliary winding for obtaining a part of time period of the output voltage wave. Then, a total working time will be obtained by enlarging the part of time period according to a predetermined multiple and transferred into a predetermined clock. The switch 13 controlled by the switch controlling terminal according to the predetermined clock, for letting the secondary winding steadily output a secondary current to the load.

Additionally, the primary controlling circuit further comprises a timing device, a timing multiplication device and a first flip-flop. The voltage measurement terminal is used to measure the output voltage wave provided from the auxiliary winding for letting the timing device obtain the part of time period of the output voltage wave. The timing multiplication device enlarges the part of time period into the total working time according to the predetermined multiple. The first flip-flop transfers the total working time into the predetermined clock.

The timing device further comprises a first reference voltage, a reversed comparator, a reverser and a second flip-flop. Wherein, a timing signal can be obtained after the first reference voltage and the output voltage wave flow through the reversed comparator. The predetermined clock is transferred into a reversed predetermined clock by the reverser. The timing signal, the reversed predetermined clock and a data signal S4 are transferred into the part of time period by the second flip-flop. The timing multiplication device enlarges the part of time period into the total working time according to the predetermined multiple, the first flip-flop transfers the total working time into the predetermined clock.

Furthermore, in practice that the primary controlling circuit further comprises a second reference voltage and a comparator. A signal can be obtained by the second reference voltage and a voltage wave flowing through the comparator. The total working time and the signal can be transferred in to the predetermined clock by the first flip-flop.

Compared to the prior art, the primary controlling circuit of the flyback energy converter further comprises the timing multiplication device. The timing multiplication device enlarges the part of time period into the total working time according to the predetermined multiple. Take the total working time as the switching cycle of the switch, the steady output current can be obtained.

The advantage and spirit of the invention may be understood by the following recitations together with the appended drawings.

### BRIEF DESCRIPTION OF THE APPENDED DRAWINGS

FIG. 1 illustrates a circuit diagram of a flyback energy converter according to the prior art.

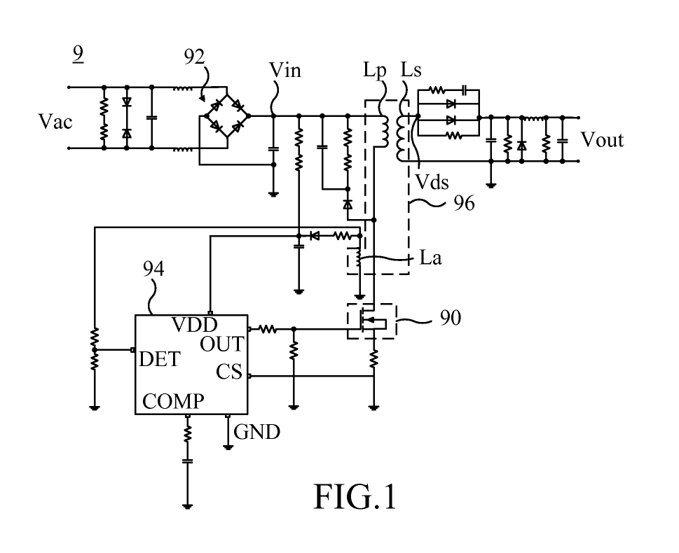

FIG. 2 illustrates a waveform diagram of a flyback energy converter according to the prior art.

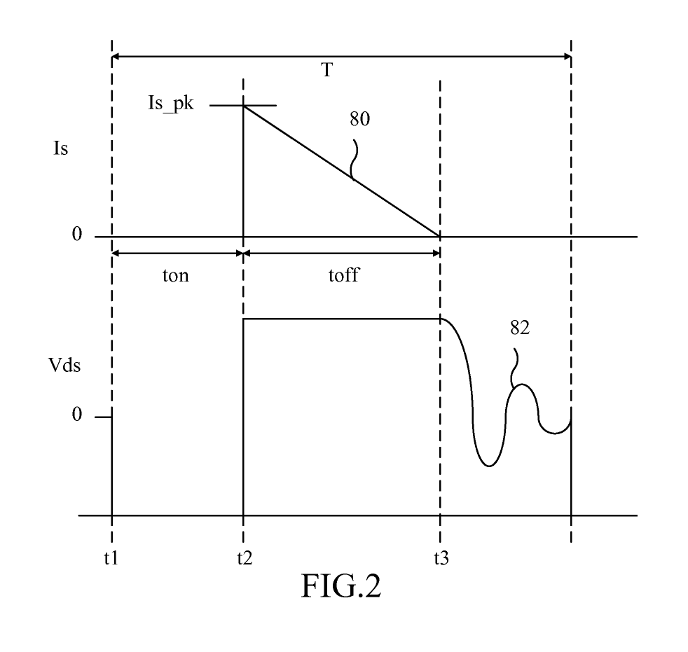

FIG. 3 illustrates a circuit diagram of a flyback energy converter according to an embodiment of the invention.

FIG. 4 illustrates a circuit diagram of a primary controlling circuit according to an embodiment of the invention.

### DETAILED DESCRIPTION OF THE INVENTION

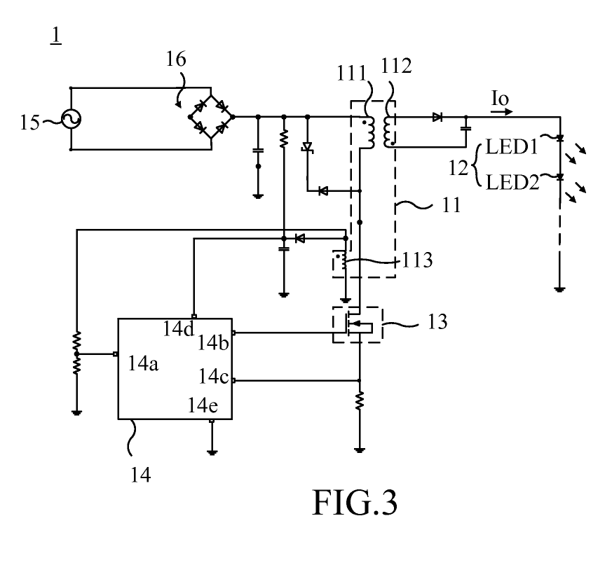

Please refer to FIG. 3. FIG. 3 illustrates a circuit diagram of a flyback energy converter according to an embodiment of the invention. The invention is to provide a flyback energy converter 1 comprising a transformer 11, a load 12, a switch 13, a primary controlling circuit 14, a power supply 15 and a bridge rectifier circuit 16.

The transformer 11 comprises a primary winding 111, a secondary winding 112 and an auxiliary winding 113. In the embodiment, the primary winding 111 is electrically connected to a power supply 15 through a bridge rectifier circuit 16. The power supply 15 is an alternating current power supply.

The load 12 is electrically connected to the secondary winding 112. In the embodiment, the load 12 is a plurality of light emitting diodes (LED1, LED2).

The switch 13 is serially connected to the primary winding 111 for controlling a primary current of the primary winding 111.

The primary controlling circuit 14 comprises a first voltage measurement terminal 14a and a switch controlling terminal 14b. Wherein, the voltage measurement terminal 14a is used to measure an output voltage wave provided from the auxiliary winding 113 for obtaining a part of time period of the output voltage wave. Then, a total working time will be obtained by enlarging the part of time period according to a predetermined multiple and transferred into a predetermined clock. The switch 13 is controlled by the switch controlling terminal 14b according to the predetermined clock, for letting the secondary winding 112 steadily output a secondary current to the load 12. In the embodiment, the part of output voltage wave is a positive half-wave.

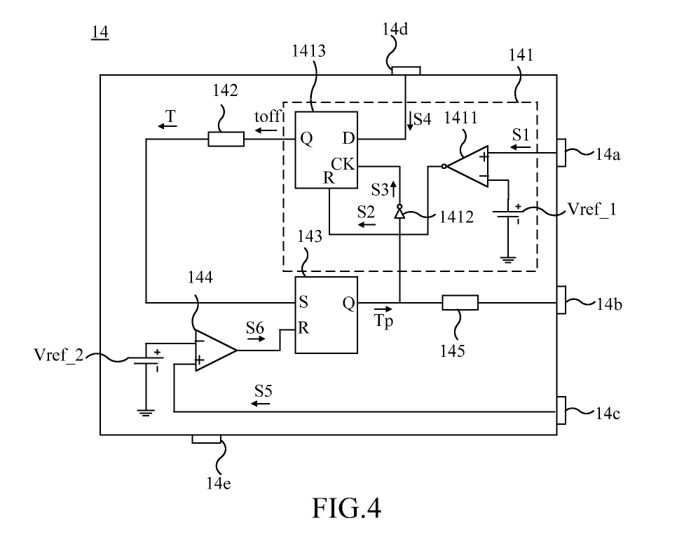

Please refer to FIG. 4. FIG. 4 illustrates a circuit diagram of a primary controlling circuit according to an embodiment of the invention. As shown in FIG. 4, the primary controlling circuit 14 comprises a timing device 141, a timing multiplication device 142 and a first flip-flop 143. The voltage measurement terminal 14a is used to measure the output voltage wave Si provided from the auxiliary winding 113 for letting the timing device 141 obtain the part of time period toff of the output voltage wave. The timing multiplication device 142 enlarges the part of time period toff into the total working time T according to the predetermined multiple. The first flip-flop 143 transfers the total working time T into the predetermined clock Tp.

To be noticed, in the embodiment the timing device 141 comprises a first reference voltage Vref_1, a reversed comparator 1411, a reverser 1412 and a second flip-flop 1413. Wherein, the a timing signal S2 can be obtained after the first reference voltage Vref_1 and the output voltage wave S1 flow through the reversed comparator 1411. The predetermined clock Tp is transferred into a reversed predetermined clock S3 by the reverser 1412. The timing signal S2, the reversed predetermined clock S3 and a data signal S4 of a data source 14d are transferred into the part of time period toff by the second flip-flop 1413.

Please refer to FIG. 4 again. The primary controlling circuit 14 further comprises a second reference voltage Vref_2, a comparator 144 and a switch driving circuit 145. A signal S6 can be obtained by the second reference voltage Vref_2 and a voltage wave S5 flowing through the comparator 144 and the switch driving circuit 145. The total working time T and the signal S6 can be transferred in to the predetermined clock Tp by the first flip-flop 143. The switch driving circuit 145 controls the switch 13 by the switch controlling terminal 14b according to the predetermined clock Tp. To be noticed that the primary controlling circuit 14 further comprises a grounding terminal 14e.

Compared to prior art, the primary controlling circuit of the flyback energy converter comprises the timing multiplication device enlarges the part of time period into the total working time according to the predetermined multiple. Take the total working time as the switching cycle of the switch for outputting currents steadily.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A flyback energy converter, comprising:
a transformer comprising a primary winding, a secondary winding and an auxiliary winding, wherein the primary winding is electrically connected to a power supply;
a load electrically connected to the secondary winding;
a switch serially connected to the primary winding for controlling a primary current, wherein the primary current flows through the primary winding; and
a primary controlling circuit comprising a voltage measurement terminal and a switch controlling terminal;
wherein the voltage measurement terminal is used to measure an output voltage wave provided from the auxiliary winding for obtaining a part of time period of the output voltage wave, then a total working time will be obtained by enlarging the part of time period according to a predetermined multiple and transferred into a predetermined clock, the switch is controlled by the switch controlling terminal according to the predetermined clock, for letting the secondary winding steadily output a secondary current to the load.

2. The flyback energy converter of claim 1, wherein the output voltage wave is a positive half-wave.

3. The flyback energy converter of claim 1, wherein the primary controlling circuit further comprises a timing device, a timing multiplication device and a first flip-flop, the voltage measurement terminal is used to measure the output voltage wave provided from the auxiliary winding for letting the timing device obtain the part of time period of the output voltage wave, the timing multiplication device enlarges the part of time period into the total working time according to the predetermined multiple, the first flip-flop transfers the total working time into the predetermined clock.

4. The flyback energy converter of claim 3, wherein the timing device further comprises a first reference voltage, a reversed comparator, a reverser and a second flip-flop, a timing signal can be obtained after the first reference voltage and the output voltage wave flow through the reversed comparator, the predetermined clock is transferred into a reversed predetermined clock by the reverser, the timing signal, the reversed predetermined clock and a data signal are transferred into the part of time period, the timing multiplication device enlarges the part of time period into the total working time according to the predetermined multiple, the first flip-flop transfers the total working time into the predetermined clock.

5. The flyback energy converter of claim 3, wherein the primary controlling circuit further comprises a second reference voltage and a comparator, a signal can be obtained by the second reference voltage and a voltage wave flowing through the comparator, the total working time and the signal can be transferred in to the predetermined clock by the first flip-flop.

6. The flyback energy converter of claim 1, wherein the primary controlling circuit further comprises a switch driving circuit, the switch driving circuit controls the switch by the switch controlling terminal according to the predetermined clock.

7. The flyback energy converter of claim 1, wherein the primary controlling circuit further comprises a grounding terminal.

8. The flyback energy converter of claim 1, wherein the load is at least one light emitting diode.

9. The flyback energy converter of claim 1, wherein the primary winding is electrically connected to the power supply through a bridge rectifier circuit.

10. The flyback energy converter of claim 1, wherein the power supply is an alternating current power supply.
